(19) United States
(12) Patent Application Publication
(10) Pub. No.: US 2020/0308042 A1
(43) Pub. Date: Oct. 1, 2020

(54) METHOD OF MANUFACTURING MULTICORE OPTICAL FIBER

(71) Applicant: Sumitomo Electric Industries, Ltd., Osaka (JP)

(72) Inventors: Takuji Nagashima, Osaka (JP); Shuhei Toyokawa, Osaka (JP)

(21) Appl. No.: 16/734,598

(22) Filed: Jan. 6, 2020

(30) Foreign Application Priority Data
Mar. 29, 2019 (JP) 2019-066268

(51) Int. Cl. C03B 37/027

(52) U.S. Cl. CPC C03B 37/027; G02B 6/02042

(57) ABSTRACT

The disclosure provides a method of manufacturing a multicore optical fiber comprising a plurality of cores and a common cladding covering each of the plurality of cores and having a non-circular cross-sectional shape capable of passive alignment. The method includes providing an optical fiber preform having a cross-sectional shape delimited by a line obtained by replacing a part of a circumference with one chord or two chords parallel to each other, and applying a drawing tension to one end of the optical fiber preform to draw a multicore optical fiber. An aspect ratio x of the cladding defined by a ratio of a radius of a circle defining the circumference to a distance from the center of the circle to the chord and a drawing tension y are set so that the common cladding has a depression at the center of a plane corresponding to the one or each of the two chords.

### TECHNICAL FIELD

The present disclosure relates to a method of manufacturing a multicore optical fiber.

### BACKGROUND ART

A multicore optical fiber includes a plurality of cores covered with a common cladding so as to increase the transmission capacity per an optical fiber. Connecting two multicore optical fibers requires not only aligning the center axes of the multicore optical fibers, but also aligning the positions of the cores or a marker on the common cladding by rotating the multicore optical fibers about their center axes.

When the multicore optical fiber has a circular shape in a cross-sectional view, it is not easy to align an arrangement direction of the cores in a specific direction. For example, JP2017-146342A (Patent Literature 1), JP2013-205557A (Patent Literature 2), and JP2015-118270A (Patent Literature 3) disclose a multicore optical fiber having a substantially D-shaped cross-section perpendicular to its longitudinal direction, in which a portion of the outer surface of the common cladding is cut out to form a flat surface. US2017/0082797A (Patent Literature 4) discloses a multicore optical fiber in which a recess is formed in the outer surface of the common cladding.

### SUMMARY OF INVENTION

### Technical Problem

An object of the present disclosure is to provide a method for easily manufacturing a multicore optical fiber having a non-circular cross-sectional shape that can be aligned without directly observing the positions of the cores or a marker.

### Solution to Problem

The present disclosure relates to a method of manufacturing a multicore optical fiber including a plurality of longitudinally extending cores and a common cladding covering each of the plurality of cores. The first aspect of the manufacturing method of the present disclosure includes: a step of preparing an optical fiber preform in which the common-cladding has a cross-sectional shape delimited by a circumferential line that is partially replaced with one chord or two parallel chords; and a step of applying a drawing tension to one end of the optical fiber preform so as to draw the preform into a multicore optical fiber, wherein the drawing tension and the common cladding's aspect ratio defined by the ratio of a radius of the circumference to a distance between the center of the circumference and the chord are set so that the common cladding may have a depression at the center of a plane corresponding to the one chord or each of the two parallel chords.

The second aspect of the manufacturing method of the present disclosure includes: a step of providing an optical fiber preform having a cross-sectional shape delimited by two parallel straight lines of equal length and two arcs connecting the two straight lines; and a step of applying a drawing tension to one end of the optical fiber preform so as to draw into a multicore optical fiber, wherein the drawing tension and the cladding's aspect ratio defined by the ratio of the maximum length of a straight line, which is parallel to the two straight lines and intersects with each of the two arcs, to the distance between the two straight lines are set so that the common cladding may have a depression at the center of a plane corresponding to each of the two straight lines.

In either of the manufacturing methods of the first aspect and the second aspect, the aspect ratio x may be 1.24 or more, and the drawing tension y expressed in units N may satisfy the inequality:

y≥−11.594x³+65.369x²−124.40x+80.788.

In addition, the aspect ratio x may be 1.53 or more. Furthermore, the aspect ratio x may be less than or equal to 1.6, and the drawing tension y may satisfy an inequality:

y≥43.59x³−232.86x²+413.76x−240.46.

The aspect ratio x may be 1.6 or less.

### Advantageous Effects of Invention

According to the manufacturing method of the present disclosure, it is possible to easily manufacture a multicore optical fiber which has a depression in the outer surface of the common cladding.

### BRIEF DESCRIPTION OF DRAWINGS

FIG. 1A is a cross-sectional view of an exemplary optical fiber preform prepared in the disclosed method of manufacturing a multicore optical fiber.

FIG. 1B is a cross-sectional view of an exemplary multicore optical fiber obtained by drawing the optical fiber preform of FIG. 1A.

FIG. 1C is a cross-sectional view of another embodiment of the multicore optical fiber obtained by drawing the optical fiber preform of FIG. 1A.

FIG. 2A is a conceptual view of measuring an outer diameter of a multicore optical fiber having a non-circular cross-section.

FIG. 2B is a conceptual diagram of a facility configuration for measuring an outer diameter of a multicore optical fiber having a non-circular cross-section.

FIG. 3 is a cross-sectional view of an example of a multicore optical fiber manufactured by the manufacturing method according to one embodiment of the present disclosure.

FIG. 4 is a graph for explaining the relationship between the aspect ratio of the cladding of the optical fiber preform and the minimum value of drawing tension that is required for setting the amount of deviation from the arc of a first convex surface or a second convex surface to 1 μm or less within the angular range of 45° shown in FIG. 3.

FIG. 5 is a graph for explaining the relationship between the aspect ratio of the cladding and the minimum value of the drawing tension for providing the depression in the surface corresponding to each of the first surface and the second surface.

### DESCRIPTION OF EMBODIMENTS

The cross-sectional shapes described in Patent Literatures 1 to 4 are helpful for aligning cores or a marker without direct observations of their positions. Such aligning method is referred to as “passive alignment”. However, Patent Literatures 1, 2, and 4 do not describe any specific methods for forming the common cladding into the above-mentioned cross-sectional shapes. Patent Literature 3 includes a generic description of a manufacturing process for an optical fiber preform, but does not describe a quantitative relation between the shape of an optical fiber preform and the drawing condition required to obtain the target cross-sectional shape. In general, when the optical fiber preform is softened by heating, the surface tension acts on the outer periphery of the optical fiber preform in such manner as to reduce the curvature of the cross-sectional shape of the optical fiber preform. Therefore, even if an optical fiber preform having a non-circular cross-sectional shape is used, it is difficult to form a multicore optical fiber having a non-circular cross-sectional shape similar to the cross-sectional shape of the optical fiber preform.

The present disclosure focuses on the fact that, in order to provide a depression in the center of the respective surface of a multicore optical fiber, which surface is originated from a surface constituting the respective chord in the cross-sectional shape of a non-circular optical fiber preform, it is necessary to change the drawing tension depending on the aspect ratio of the cross-section of the optical fiber preform. As the aspect ratio of the cladding increases, the drawing tension required to obtain the depression decreases, and as the aspect ratio decreases, the necessary drawing tension increases. Therefore, by determining the drawing tension depending on the aspect ratio, it is possible to easily manufacture a multicore optical fiber having a depression provided in the center of the surface corresponding to the chord.

Hereinafter, preferred embodiments of a method for manufacturing a multicore optical fiber according to the present disclosure will be described with reference to the accompanying drawings. The disclosed embodiments are to be considered in all respects as illustrative and not restrictive. The present invention is defined by the claims, and includes all modifications within the scope of equivalents to the claims.

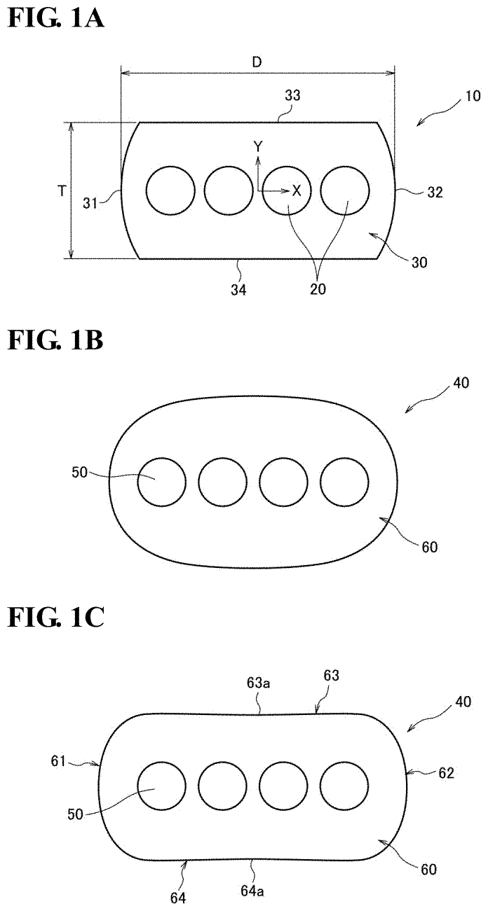

FIG. 1A is a cross-sectional view of an exemplary optical fiber preform 10 prepared in the disclosed method of manufacturing a multicore optical fiber. The optical fiber preform 10 is made of, for example, quartz glass, has a plurality of cores 20 (four cores in this example) and a common cladding 30 covering each core 20, and extends in the direction perpendicular to the plane of paper showing this figure. In the illustrated cross-section, the cores 20 are arranged at equal intervals along the X-axis. The cladding 30 surrounds the entire circumference of the four cores 20 and has a non-circular shape symmetrical with respect to both the X-axis and the Y-axis perpendicular to the X-axis.

In the illustrated cross-section, the cladding 30 is surrounded with two parallel straight lines of equal length and two arcs connecting the two straight lines. The optical fiber preform 10 has a first convex surface 31 and a second convex surface 32, which are mutually line symmetric with respect to the Y axis that is the minor axis of the cladding 30, and the upper surface 33 and the lower surface 34, which are mutually line symmetric with respect to the X axis that is the major axis of the cladding 30.

The first convex surface 31 protrudes to curve away from the center of the cladding 30. The second convex surface 32 is, for example, on a circumference different from the circumference constituting the first convex surface 31 and similarly to the first convex surface 31 protrudes to curve away from the center of the cladding 30. The second convex surface may be on the same circumference as the circumference constituting the first convex surface 31. In this case, the cross-section of the optical fiber preform 30 has a shape delimited by a line obtained by replacing a part of the circumference with one chord or two parallel chords.

The upper surface 33 is parallel to the X-axis and is located closer to the center of the cladding 30 than the circumference constituting each of the first convex surface 31 and the second convex surface 32. The lower surface 34 is parallel to the X-axis at a position opposite to the upper surface 33 with the center of the cladding 30 interposed therebetween and similarly to the upper surface 33 is located on the more inner side of the cladding 30 than the circumference constituting each of the first convex surface 31 and the second convex surface 32. The upper surface 33 and the lower surface 34 correspond to chords described in the claims.

In the illustrated cross-section of the optical fiber preform 10, the cross-sectional shape of the cladding can be expressed by the aspect ratio D/T, where D is the length of the long axis of the cladding 30, which is the distance along the X-axis from the first convex surface 31 to the second convex surface 32, and T is the length of the short axis of the cladding 30, which is the distance along the Y-axis from the upper surface 33 to the lower surface 34. In the case of a cladding having only one of the upper surface 33 and the lower surface 34, in the illustrated cross section, the outer peripheral shape of the cladding is a shape surrounded by one chord of a circle, whose center is on the intersection of the X-axis and the Y-axis, and one arc connecting both ends of the one chord. The aspect ratio can be expressed by R/d, where R is the radius of the circle and d is the distance from the center of the circle to the chord.

FIG. 1B and FIG. 1C are cross-sectional views of the multicore optical fiber 40 obtained by drawing the optical fiber preform 10. An optical fiber preform 10 having a non-circular cross-section is prepared, arranged in a drawing furnace, and drawn into an optical fiber, while heating one end of the optical fiber preform 10.

When a predetermined drawing tension is applied to one end of the optical fiber preform 10 and the drawing is performed, for example, at a take up speed of 150 m/min under the furnace temperature of 2400K, the surfaces of the common cladding 60 of the multicore optical fiber 40 corresponding to the upper surface 33 and the lower surface 34 of the optical fiber preform 10 slightly bulge outward as shown in FIG. 1B. On the other hand, if the take up speed is 150 m/min and the furnace temperature is 2300 K, the common cladding 60 of the multicore optical fiber 40 thus formed has, as shown in the FIG. 1C, a depression of about 0.2 μm respectively at the center of the upper surface 63 corresponding to the upper surface 33 of the optical fiber preform 10 and at the center of the lower surface 64 corresponding to the lower surface 34. In this manner, when the drawing is performed at a sufficiently low furnace temperature such as 2300 K, the multicore optical fiber 40 having a depression at the center of the flat surface can be obtained.

Since the common cladding 60 having depressions on the upper surface 63 and the lower surface 64 can touch a plane at least at two points, the cores of multicore optical fibers can easily be aligned in a desired direction. In addition, since the outer periphery of the optical fiber preform 10 is simply ground into a planar shape to form the upper surface 33 and the lower surface 34, the common cladding 60 can easily be made as compared with the case where the optical fiber preform 10 must be cut out as in the case of Patent Literature 3.

In order to provide a depression at the center of each of the upper surface 63 and the lower surface 64 of the common cladding 60, it is useful to increase the aspect ratio of the cladding 30 of the optical fiber preform 10, that is, to widen the upper surface 33 and the lower surface 34. However, when the aspect ratio is simply increased, the cross-sections of the first convex surface 31 and the second convex surface 32 are liable to deviate from the arc due to the surface tension generated at the time of heating. This reduces the accuracy in the measurement of the outer diameter of the multicore optical fiber 40.

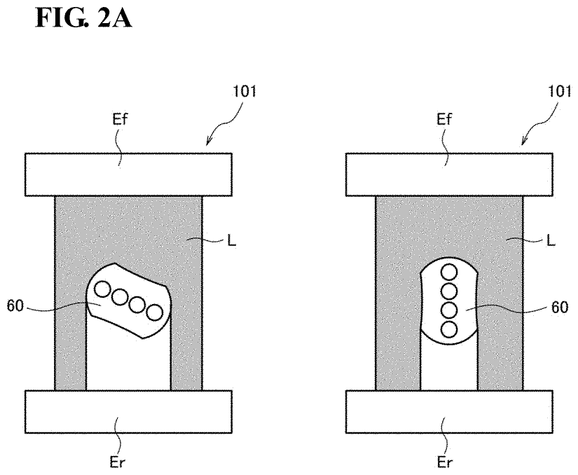

FIG. 2A is a conceptual view of measuring the outer diameter of a multicore optical fiber having a non-circular cross-section, and FIG. 2B is a conceptual view of a facility configuration therefor. The multicore optical fiber 40 is drawn downward from the optical fiber preform 10 and reaches the detection device 101. The outer diameter of the multicore optical fiber 40 is optically detected using the detection device 101. The detection device 101 includes a projector Ef that emits predetermined inspection light L, and a line sensor Er that receives light from the projector Ef. The line sensor Er may be a phototransistor, a photodiode, a charged coupled device, complementary metal oxide semiconductor, or a photosensor arranged on a line.

The detection device 101 is placed, for example, on the downstream side of a cooling device (not shown). The projector Ef and the line sensor Er are arranged on the same horizontal plane, and the inspection light L emitted from the projector Ef also travels on the horizontal plane. When a common cladding 60 is non-circular, if the direction of the common cladding 60 changes in the detecting device 101 as shown in the FIG. 2A, different outer diameter values will be outputted with respect to the same common cladding 60. In such case, since the common cladding 60 cannot be accurately measured, it will be difficult to supply an appropriate feedback to the control for making the cladding diameter constant at the time of drawing.

To solve such problem, for example, four detecting devices 101-104 may be provided as shown in the FIG. 2B in such manner as the travelling directions of the test light rays L are shifted by 45 degrees respectively. More specifically, the detecting device 101 has a projector Ef at a predetermined reference position. The detection devices 102, 103, and 104 are disposed in order on the downstream side of the detection device 101 in the following manner: the detection device 102 is disposed at +45 deg with respect to the reference position; the detection device 103 is disposed at +90 deg with respect to the reference position; and the detection device 104 is disposed at +135 deg with respect to the reference position. When the shape has an aspect ratio of 2.6 or less, the multicore optical fiber 40 can be measured by adopting the maximum value of the values detected by the four detection devices 101-104 as the outer diameter of the multicore optical fiber 40. The multicore optical fiber 40 whose outer diameter is measured by the detection devices 101-104 is added with a resin layer by the die 110, guided to the capstan 130 via the pulley 120, and wound on the bobbin 140.

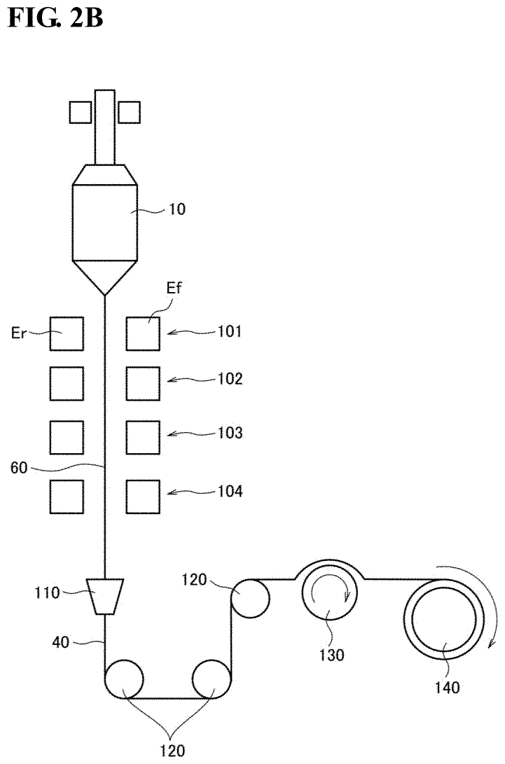

FIG. 3 is a cross-sectional view of a multicore optical fiber 40 produced by drawing an optical fiber preform 10 at a take up speed of 150 m/min under a furnace temperature of 2300 K. The multicore optical fiber 40 has a plurality of cores 50 (e.g., four cores 50) and the common cladding 60 covering each core 50 and extends in the direction perpendicular to the plane of paper showing this FIG. 3. In the illustrated cross-section, the cores 50 are arranged at equal intervals along a straight line (X-axis). The common cladding 60 surrounds the entire circumference of the four cores 50 and has a non-circular shape that is line-symmetric with respect to both the X-axis and the Y-axis, which is perpendicular to the X-axis.

The outer peripheral shape of the multicore optical fiber 40 has a first convex surface 61 and a second convex surface 62, which are formed at the positions that are line-symmetric with respect to the Y-axis that is the minor axis of the common cladding 60, and an upper surface 63 and a lower surface 64, which are line-symmetric with respect to the X-axis that is the major axis of the common cladding 60. The surfaces 63 and 64 in the illustrated cross section correspond to the “chord” in the claims. More specifically, the first convex surface 61 protrudes curving away from the center of the common cladding 60. The second convex surface 62 is formed, for example, on a circumference different from the circumference that constitutes the first convex surface 61 and similarly to the first convex surface 61 protrudes curving away from the center of the common cladding 60. The second convex surface 62 may be on the same circumference as the circumference constituting the first convex surface 61.

The upper surface 63 is substantially parallel to the X-axis and is located closer to the center of the common cladding 60 than the circumferences constituting the first convex surface 61 and the second convex surface 62. The lower surface 64 is substantially parallel to the X-axis at a position opposite to the upper surface 63 with the center of the common cladding 60 interposed therebetween and similarly to the upper surface 63 is located closer to the center of the common cladding 60 than the circumferences constituting the first convex surface 61 and the second convex surface 62. The upper surface 63 or the lower surface 64 functions as a reference surface when the multicore optical fibers are connected to each other. A depression 63a of about 0.2 μm is formed in the center of the upper surface 63, and a depression 64a of about 0.2 μm is also formed in the center of the lower surface 64.

The number of required detecting devices described in FIG. 2B is determined by the aspect ratio of the cladding 30 of the optical-fiber preform 10. If the aspect ratio is 2, at least three devices are required, and if the aspect ratio is square root of 2, at least two devices are required. In the case of using four detection devices 101-104, the variation in the outer diameter of the common cladding 60 can be detected with an accuracy of ±2.0 μm if the “arc deviation amount”, which is defined by a distance between the first convex surface 61a or the second convex surface 62a and the circumference contacting the first convex surface 61a or the second convex surface 62a, is equal to or less than ±1.0 μm within the angle range in which the center angle around the contact point of the circumference and the first convex surface 61a or the second convex surface 62 is 45 deg or less as shown in FIG. 3.

In order to reduce the amount of arc deviation, the aspect ratio of the cladding 30 of the optical fiber preform 10 may be reduced, that is, the upper surface 33 and the lower surface 34 may be narrowed. On the other hand, if the aspect ratio is simply reduced, the drawing tension for obtaining the depression 63a and the depression 64a respectively in the center of the upper surface 63 or the lower surface 64 of the common cladding 60 must be increased, which is liable to break the multicore optical fiber 40.

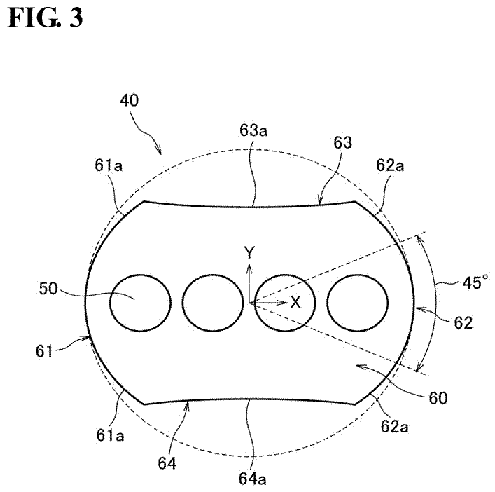

FIG. 4 is a graph showing the relationship between the aspect ratio of the cladding 30 of the optical fiber preform and the minimum value of the drawing tension for making the arc deviation amount within the angular range 45 deg shown in FIG. 3 to 1 μm or less. The abscissa x shows the aspect ratio of the cladding 30 of the optical fiber preform 10 and the ordinate y shows the drawing tension, and the aspect ratio x and the drawing tension y expressed in unit N for reducing the arc deviation to 1.0 micrometer or less at angles of 45 degrees around the center of the common cladding 60 satisfy the inequality:

y≥43.59x³−232.86x²+413.76x−240.46.

It is understood that the aspect ratio of the cladding 30 of the optical fiber preform needs to be equal to or less than 2.08 in order to make the arc deviation amount equal to or less than 1.0 μm when the drawing tension is set to be equal to or less than 5 N in order to avoid disconnection during drawing. At this time, the outer diameter of the multicore optical fiber can be measured by four detection devices. When the fiber drawing tension is set to be equal to or less than 4 N in order to more reliably avoid disconnection during fiber drawing, it is understood that the aspect ratio of the cladding 30 of the optical fiber preform needs to be equal to or less than 1.6 in order to make the arc deviation amount equal to or less than 1.0 μm.

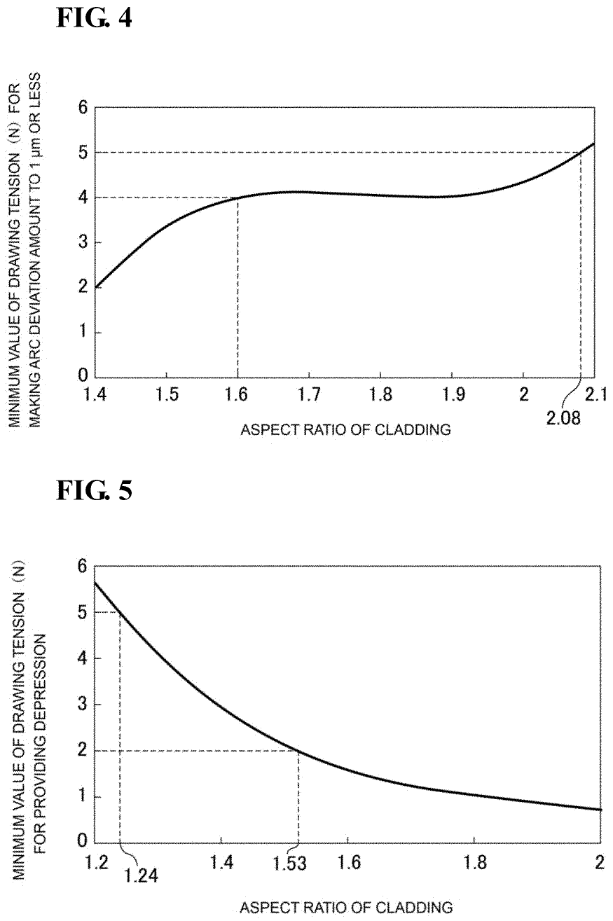

FIG. 5 is a graph showing the relationship between the aspect ratio of the cladding 30 and the minimum value of the drawing tension for providing a 0.2 μm depression in the center of the plane corresponding to each of the two chords. The abscissa x shows the aspect ratio of the cladding 30 and the ordinate y shows the drawing tension. The aspect ratio x and the drawing tension y expressed in unit N for providing the depressions in the respective center of the upper surface 63 and the lower surface 64 of the common cladding 60 satisfy the inequality:

y≥11.594x³+65.369x²−124.40x+80.788

When the drawing tension is set to 5 N in order to avoid disconnection during drawing, it is understood that the aspect ratio of the cladding 30 of the optical fiber preform needs to be 1.24 or more in order to provide a depression of about 0.2 μm at the center of the surface corresponding to each of the two chords. At this time, passive alignment can easily be realized. When the drawing tension is set to be equal to or less than the 2N in order to more reliably avoid disconnection during drawing, it is understood that the aspect ratio of the cladding 30 needs to be equal to or greater than 1.53.

In this manner, a multicore optical fiber having a depression formed in the center of the upper surface 63 or the lower surface 64 can be easily manufactured by setting the drawing tension to be lower when the aspect ratio of the cladding 30 is relatively large, or by setting the drawing tension to be higher when the aspect ratio is relatively small.

### REFERENCE SIGNS LIST

```
  10: optical fiber preform,
  20: core,
  30: cladding,
  31: first convex surface,
  32: second convex surface,
  33: top,
  34: bottom,
  40: multicore optical fiber,
  50: core,
  60: common cladding,
  61: first convex surface,
  61a: end portion of the first convex surface,
  62: second convex surface,
  62a: end portion of the second convex surface,
  63: top,
  63a: depression,
  64: bottom,
  64a: depression,
101, 102, 103, 104: detection device,
110: die,
120: pulley,
130: capstan,
140: bobbin
```

What is claimed is:

1. A method of manufacturing a multicore optical fiber including a plurality of longitudinally extending cores and a common cladding covering each of the plurality of the cores, the method comprising:
providing an optical fiber preform having a cross-sectional shape delimited by a circumferential line partially replaced with one chord or two parallel cords, and
applying a drawing tension to one end of the optical fiber preform to draw into the multicore optical fiber, wherein
the drawing tension y and the aspect ratio x of the cladding defined by the ratio of a radius of a circle defining the circumference to a distance from a center of the circle to the chord are set such that the common cladding has a depression at a center of a plane corresponding to the one chord or each of the two parallel chords.

2. The method of manufacturing a multicore optical fiber according to claim 1, wherein
the aspect ratio x is greater than or equal to 1.24 and the drawing tension y expressed in unit N satisfies an inequality:
y≥−11.594x³+65.369x²−124.40x+80.788.

3. The method of manufacturing a multicore optical fiber according to claim 2, wherein
the aspect ratio is 1.53 or more.

4. The method of manufacturing a multicore optical fiber according to claim 3, wherein
said aspect ratio x is 2.08 or less, and said drawing tension y expressed in unit N satisfies an inequality:
y≥43.59x³−232.86x²+413.76x−240.46.

5. The method for manufacturing a multicore optical fiber according to claim 4, wherein
the aspect ratio is 1.6 or less.

6. A method of manufacturing a multicore optical fiber including a plurality of longitudinally extending cores and a common cladding covering each of the plurality of the cores, the method comprising:
providing an optical fiber preform having a cross-sectional shape delimited by two parallel straight lines of equal length and two arcs connecting the two straight lines; and
applying a drawing tension to one end of the optical fiber preform to draw into the multicore optical fiber, wherein
the drawing tension y and the aspect ratio x of the cladding defined by the ratio of a maximum length between two points at which a straight line parallel to the two straight lines intersects with each of the two arcs to a distance between the two straight lines are set such that the common cladding has a depression at a center of a plane corresponding to each of the two straight lines.

7. The method of manufacturing a multicore optical fiber according to claim 6, wherein
the aspect ratio x is greater than or equal to 1.24 and the drawing tension y expressed in unit N satisfies an inequality:
y≥−11.594x³+65.369x²−124.40x+80.788.

8. The method of manufacturing a multicore optical fiber according to claim 7, wherein
the aspect ratio is 1.53 or more.

9. The method of manufacturing a multicore optical fiber according to claim 8, wherein
said aspect ratio x is 2.08 or less, and said drawing tension y expressed in unit N satisfies an inequality:
y≥−43.59x³−232.86x²+413.76x−240.46.

10. The method for manufacturing a multicore optical fiber according to claim 9, wherein
the aspect ratio is 1.6 or less.
